(19) United States
(12) Patent Application Publication
(10) Pub. No.: US 2011/0259280 A1
(43) Pub. Date: Oct. 27, 2011

(54) MULTI-PURPOSE BAG

(76) Inventors: Catherine Partridge, Orlando, FL (US); April Mary Macken, Winter Garden, FL (US)

(21) Appl. No.: 13/092,935

(22) Filed: Apr. 23, 2011

Related U.S. Application Data
(60) Provisional application No. 61/327,473, filed on Apr. 23, 2010.

(51) Int. Cl. A01K 13/00; B65D 65/00; B65D 30/22; A01K 29/00; B65D 33/16

(52) U.S. Cl. 119/601; 119/652; 383/71; 383/42; 383/38; 383/105

(57) ABSTRACT

A pet drying and cleaning bag is made of a piece of material having two opposite ends joined together to form an open-ended material. One of the unjoined ends is kept fully open while the other unjoined end is partially joined together, leaving an opening in at least a portion of this other unjoined end. This opening may be closable and may also be elastically expandable. Some embodiments of the pet drying bag may include closure mechanisms, such as zippers or hook and loop fasteners, to provide additional openings in the bag. The bag of the present invention may be made larger to act as a beach bag, towel, and privacy changing screen.

### CROSS-REFERENCE TO RELATED APPLICATIONS

This application claims the benefit of priority of U.S. provisional patent application No. 61/327,473, filed Apr. 23, 2010, the contents of which are herein incorporated by reference.

### BACKGROUND OF THE INVENTION

The present invention generally relates to a multi-purpose bag and, more particularly, to a multi-purpose bag with an open first end and a closable second end. The multi-purpose bag may be used for pet drying, permitting the pet to enter and exit the drying bag at will, pet grooming, for carrying beach supplies, as a beach towel and as a privacy cover for changing clothes.

Although towels are well-known in the art, a simple, low cost solution for a convenient, pet-friendly grooming towel that may not require a user to individually wipe the pet's feet has not been developed for cleaning and drying small animals, such as dogs and cats, that have been exposed to mud, dirt, snow, rain, baths, lakes, swimming pools and the like.

One problem with cleaning and drying small animals is that they absorb large amounts of dirt, mud and water that may soil surrounding objects. Another problem is that animals instinctively shake themselves when they are dirty or wet, casting off large amounts of dirt, mud and water on surrounding objects. Immediate action is required to prevent them from soiling objects, such as clothes, cars and homes.

Conventional towels and pet drying cloths may not adequately dry a pet's body, including their feet. Some pet drying cloths are made to drape over a pet, allowing the pet to track dirt, via their paws, through undesired areas. Alternatively, pet owners using these conventional towels typically have to clean the pet's paws individually.

Conventional towels are often used at the beach for lying on the sand, drying oneself, and the like. These towels often have no additional uses and must be separately carried to the beach when used.

As can be seen, there is a need for a multi-purpose bag for pet drying, that may clean and dry a pet's fur and feet, pet grooming, as well as for beach or pool use.

### SUMMARY OF THE INVENTION

In one aspect of the present invention, a bag comprises a first open end; and a second end, opposite the first end, having an opening adapted to be opened and closed, wherein at least a portion of the bag is made of an absorbent material.

In another aspect of the present invention, a pet drying, grooming and cleaning bag comprises a first open end; a second end, opposite the first end, having an opening adapted to be opened and closed; a drawstring for opening and closing the second end of the bag; and a collar about the opening, the collar made of an elastic material, wherein at least a portion of the bag is made of an absorbent material.

In a further aspect of the present invention, a method for cleaning and drying a pet comprises directing the pet into a first open end of a bag, at least a portion of the bag being made of an absorbent material, the bag having a second end, opposite the first end, having an opening adapted to be opened and closed and a drawstring for opening and closing the second end of the bag; and moving the bag over the pet to clean or dry the pet.

These and other features, aspects and advantages of the present invention will become better understood with reference to the following drawings, description and claims.

### BRIEF DESCRIPTION OF THE DRAWINGS

FIG. 1 shows a front view of a pet drying bag according to an embodiment of the present invention;

FIG. 2 shows a bottom perspective view of the pet drying bag of FIG. 1;

FIG. 3A shows a close-up top view of a closable opening in one end of the pet drying bag of FIG. 1;

FIG. 3B shows another close-up view of the closable opening of FIG. 3A;

FIG. 4 shows the pet drying bag of FIG. 1 with a dog entering an open end of the bag;

FIG. 5 shows the pet drying bag of FIG. 1 with the dog inside the bag;

FIG. 6 shows a perspective view of a dog's head inserted through the closable opening of FIG. 3A;

FIG. 7 shows a perspective view of another dog's head inserted through the closable opening of FIG. 3A;

FIG. 8 shows a perspective view of a pet drying bag having a pocket therewithin, according to another embodiment of the present invention;

FIG. 9 shows a perspective view of a pet drying bag according to another embodiment of the present invention;

FIG. 10 shows a perspective view of a pet drying bag according to still another embodiment of the present invention; and

FIG. 11 shows a perspective view of a pet drying bag according to a further embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an exemplary embodiment of the present invention provides a pet drying and cleaning bag made of a piece of material having two opposite ends joined together to form an open-ended material. One of the unjoined ends is kept fully open while the other unjoined end is partially joined together, leaving an opening in at least a portion of this other unjoined end. This opening may be closable and may also be elastically expandable. Some embodiments of the pet drying bag may include closure mechanisms, such as zippers or hook and loop fasteners, to provide additional openings in the bag. The bag of the present invention may be made larger to act as a beach bag, towel, and privacy changing screen, as described in greater detail below.

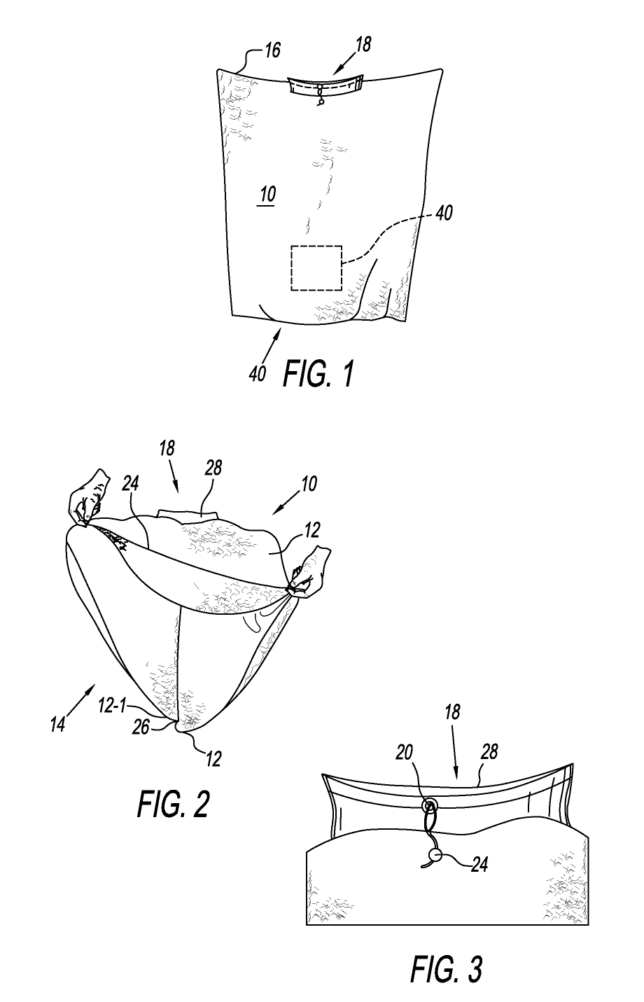

Referring to FIGS. 1 and 2, a pet bag 10 may include a piece of material 12 joined together at a first end 12-1 and a second end 12-2 to form an open ended piece of material. For example, the first end 12-1 and the second end 12-2 may be joined together by a stitched seam 26. The location of the seam 26 may be centrally located in one side of the pet bag 10, as shown in FIG. 2, or may be present in any other location. One end 14 of the material may be kept fully open. Another end 16 of the material may be partially closed, leaving an opening 18 in at least a portion of the end 16. The opening 18 may be centrally disposed in the end 16. Stitching 24 may be provided along the fully open end 14 may be provided for aesthetic reasons as well as to prevent fraying of the end 14. A collar 28, as described below, may be attached to the opening 18.

While the above description refers to one piece of material joined together at its ends, two or more pieces of material may be joined together to form a similar structure, provided that there remains one fully open end and one closable end opposite the fully open end.

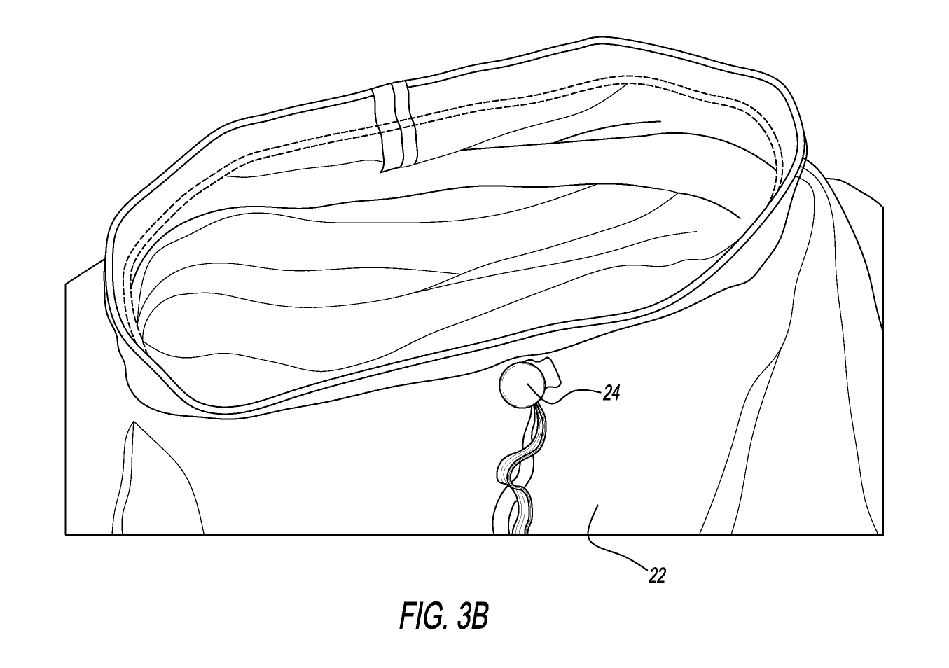

Referring to FIGS. 3A and 3B, the opening 18 may include a toggle cord 20 that may be disposed about a periphery of the opening 18. The toggle cord 20 may include a cord retaining device 22, as is known in the art, to hold ends of the cord together. The toggle cord 20 may be adjusted to change the size of the opening 18. The collar 28 of the opening 18 may be an elastic material that may further allow the opening 18 to adjust in size without using the cord 20. The collar 28 may be sized from about 5 percent to about 100 percent of the length of the end 16. Typically, the collar 28 may be sized from about 10 percent to about 30 percent of the length of the end 16, however larger collar sized may permit the pet to enter the bag at one end (e.g., fully open end 14) and exit the bag at the other end (e.g., end 16).

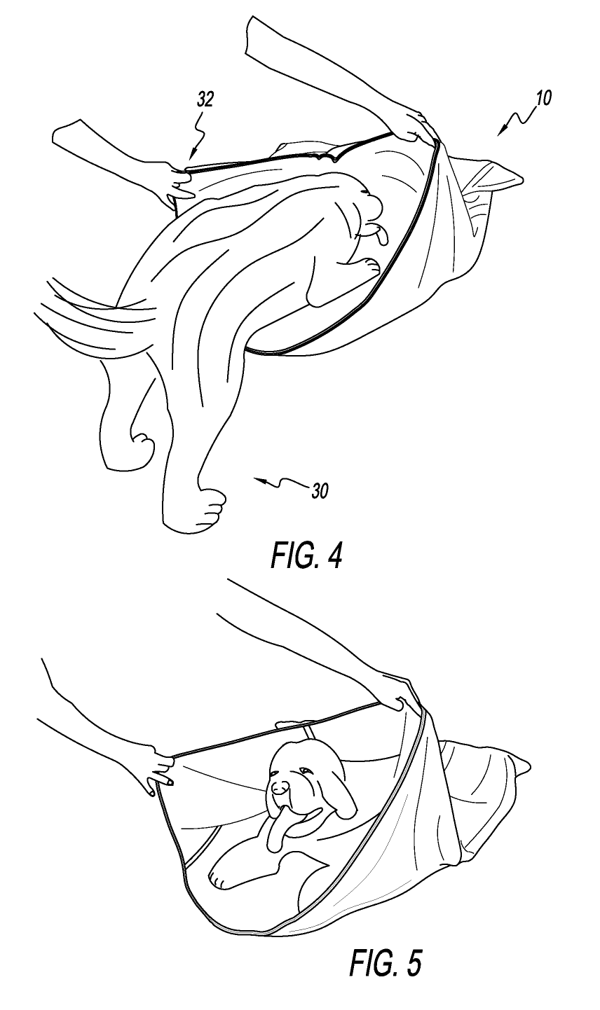

Referring to FIGS. 4 and 5, in one embodiment of the present invention, to use the pet bag 10, a user 32 may hold open the open end 14 and a dog 30 may walk or jump inside the pet bag 10. Once inside the bag 10, the dog 30 may then circle and walk about inside the pet bag 10 to clean and dry its fur and feet. Additionally, the dog 30 may rub and roll inside the bag 10. The material selected for the bag 10 may feel invigorating to the dog 30 and may encourage the dog 30 to use the bag 10, for instance, by rubbing and rolling within the bag 10. Typically, the pet bag 10 may be sized to allow ample room for the dog to circle and walk about therewithin.

In another embodiment of the present invention, an area of rigidity may be formed in at least a portion of the open end 14, thereby creating an opening to the interior of the bag 10. The area of rigidity may be formed, for example, by creating a sleeve along at least a portion of the open end 14 and inserting, for example, a flat, bowing flexible plastic member. The flexible member may be removable for laundering of the bag 10. For smaller bags 10, the flexible member may be integrated into the open end 14. This alternate embodiment, having the flexible member, may allow the bag 10 to be left on the floor, allowing the dog to access the inside of the bag 10 without human assistance. The bag 10 may be used as a pet bed, with the pet optionally resting inside the bag 10 or on top of the bag 10.

The opening 18 may be used for the initial training of the dog 30. For example, a treat (not shown) may be held inside the pet bag 10 through the opening 18 to lure the dog 30 into the bag 10. The dog 30 may retrieve the treat while inside the bag and may learn how to play inside the bag, while cleaning and drying its fur and feet.

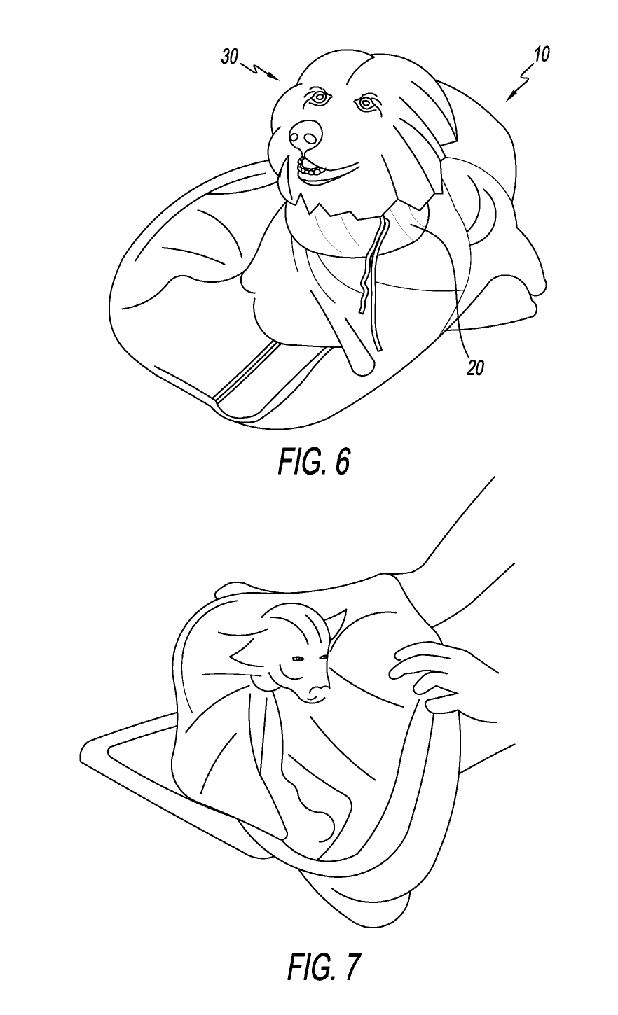

Referring to FIGS. 6 and 7, the head of the dog 30 may fit through the opening 18, allowing the user 32 to carry a wet dog, for example, out of a bath or pool, without getting wet themselves. This embodiment of the invention may also help prevent water from being spread when a wet dog shakes. By being placed in the bag 10 as shown in FIGS. 6 and 7, the water from the dog shaking may be contained within the bag 10.

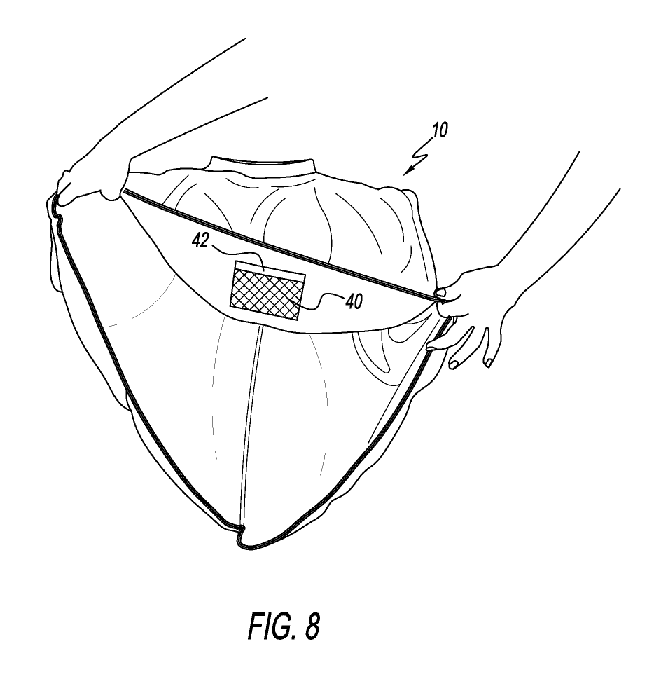

Referring now to FIG. 8, in another embodiment of the present invention, the pet bag 10 may be equipped with one or more pockets 40. The pockets may be sewn inside the bag 10. The pockets 40 may be fitted with a freshen-up pouch (not shown) that may include non- toxic odor-reducers. In this way, the dog may emerge from the bag 10 smelling fresh. The pockets 40 may be made from a breathable material, such as cotton, or a mesh material, so that the odor-reducers from the pouch may be applied to the dog. The pockets 40 may include a resealable sealing member 42 that may allow access to the inside of the pocket 40, thereby allowing users to change the pouch as needed. The pockets 40 may be located anywhere inside the bag 10. The sealing member 42 may be accessible from inside the bag, as shown in FIG. 8 or may be accessible from an exterior surface of the bag 10. In the latter embodiment, an exterior sealing member 42 may prevent the dog from opening the pocket 40 or getting caught (for example, by a nail) on the sealing member 42 while permitting the non-toxic odor-reducers to be released within the pouch through a breathable material. In one embodiment of the present invention, the pocket 40 may have a breathable material on an interior side of the pocket 40 (that is, the side facing the dog 30 when the dog 30 is in the pet bag 10) and a less permeable material on an exterior side of the pocket 40. Such a configuration may permit the non-toxic odor reducers to be delivered into the bag without loss through the side of the bag.

Referring to FIG. 9, a pet bag 10-1 may include may include one or more corners having an opening 44 therein. The opening 44 may be, for example, from about 1 inch to about 6 inches in length along a corner of the pet bag 10-1. In some embodiments, the opening 44 may permit a user to place a pet's leg at least partially through the opening 44, allowing the user to clean and/or trim the pet's nails. The opening 44 may be a continuously open opening or may be sealable via a zipper, snaps, hook and loop fasteners, or the like. In other embodiments, the opening 44 may be made from a mesh material, allowing a pet inside the bag to breathe through the opening or see out through the opening. The mesh of the opening 44 may be small enough so that the pet does not get a paw or other body part, into the opening 44. This embodiment may also be particularly suited for pet grooming, wherein a pet's claw may be extended through the opening 18, while the pet rests comfortably with its head near the mesh opening 44. This position may also be particularly suited for grooming (e.g., nail trimming) a pet that may tend to nip at the groomer. By having the pet in the pet bag 10, the pet may remain calm and the groomer protected. The opening 44 may be disposed on one or both corners of the pet bag 10-1. In some embodiments, a mesh opening may be disposed in other locations of the pet bag 10-1.

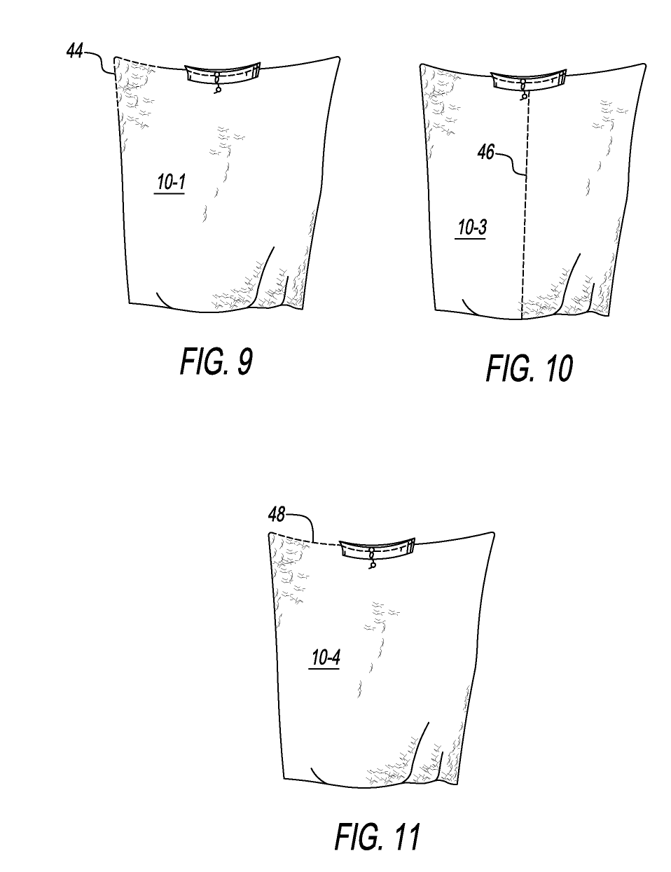

Referring to FIG. 10, a pet bag 10-2 may include a reclosable opening 46 along the length of the pet bag 10-2. The opening 46 may run from the fully open end 14 toward the opening 18 (see FIG. 1). In some embodiments, the opening 46 may run from the fully open end 14 all the way to the opening 18, allow the pet bag 10-2 to be completely opened. In other embodiments, the opening 46 may run from the fully open end 14 to just before the collar 28 (see FIG. 3), for example from about 0.5 to about 6 inches away from the collar 28. The opening 46 may be sealable via a zipper, snaps, hook and loop fasteners, or the like. The opening 46 may help remove a pet from within the pet bag 10-2.

Referring to FIG. 11, a pet bag 10-3 may include an reclosable opening 48 running from the opening 18 toward a corner of the pet bag 10-3. The opening 48 may allow the pet to easily move from one end of the bag through the opening 18. The opening 18 may be sealable via a zipper, snaps, hook and loop fasteners, or the like.

The pet bag 10 may be made of any absorbent material, including natural or synthetic materials, such as cotton, terry cloth, nylon, wool and the like. In one embodiment, the material of the pet bag 10 may provide an invigorating sensation to the dog's coat and skin, stimulating the dog to rub more inside the bag. The pet bag 10 may be made in any size convenient for the size of the pet. For example, the pet bag 10 may be made in three sizes, small medium and large, for various sizes of dogs and/or cats.

While the above embodiments describe a dog using the pet bag, embodiments of the present invention may be adapted for any animal. For example, cats, ferrets, hamsters, or the like, may use the pet bag in a manner similar to that described above.

While the above embodiments describe a bag for cleaning, drying, and grooming a pet, the bag described above may have other uses within the scope of the present invention. For example, the bag can be made as a human-sized (small, med. Large, for example) terry bag with a close-able top via drawstring so that the bag can be used to carry all beach items on to the beach (e.g., small boogie boards, change of clothes, sand toys, sunscreen, and the like). The bag may then be used as a towel to lay on, to dry off after swimming and as a portable dressing room to change out of wet beachwear into dry clothing right on the beach. The opening 18 may be adjusted with the toggle 24 to slip easily over the head. The rest of the bag may encase the person and fall all the way to or near the ground. The person may slip off wet clothing and put on dry clothing, all within the privacy of the bag. After the person emerges from the bag fully dressed, the draw string opening can be closed with the toggle 24 and all wet clothing and beach toys can be loaded into the bag and carried to the car. All sandy items may be fully contained in the bag.

It should be understood, of course, that the foregoing relates to exemplary embodiments of the invention and that modifications may be made without departing from the spirit and scope of the invention as set forth in the following claims.

What is claimed is:

1. A bag comprising:
a first open end; and
a second end, opposite the first end, having an opening adapted to be opened and closed, wherein
at least a portion of the bag is made of an absorbent material.

2. The bag of claim 1, further comprising at least one pocket sewn on an interior of the bag.

3. The bag of claim 1, further comprising a drawstring for opening and closing the second end of the bag.

4. The bag of claim 1, further comprising elastic to flexibly open the second end of the bag.

5. The bag of claim 1, further comprising a collar about the opening, the collar made of an elastic material.

6. The bag of claim 1, further comprising at least one corner opening at the second end of the bag.

7. The bag of claim 6, wherein the corner opening is made from a breathable mesh material.

8. The bag of claim 1, further comprising at least one longitudinal opening running from the first open end toward the opening at the second end.

9. The bag of claim 8, wherein the longitudinal opening runs to the opening at the second end, allowing the bag to completely open.

10. The bag of claim 8, wherein the longitudinal opening runs to a point prior to the opening at the second end.

11. The bag of claim 8, wherein the longitudinal opening is sealed by at least one of a zipper, snaps, and hook and loop fasteners.

12. The bag of claim 1, further comprising a second end opening running from the opening toward a corner at the second end of the bag.

13. The bag of claim 1, wherein the second end opening is sealed by at least one of a zipper, snaps, and hook and loop fasteners.

14. A pet drying, grooming and cleaning bag comprising:
a first open end;
a second end, opposite the first end, having an opening adapted to be opened and closed;
a drawstring for opening and closing the second end of the bag; and
a collar about the opening, the collar made of an elastic material, wherein
at least a portion of the bag is made of an absorbent material.

15. The bag of claim 14, further comprising at least one corner opening at the second end of the bag.

16. The bag of claim 14, further comprising at least one longitudinal opening running from the first open end toward the opening at the second end.

17. A method for cleaning and drying a pet, comprising:
directing the pet into a first open end of a bag, at least a portion of the bag being made of an absorbent material, the bag having a second end, opposite the first end, having an opening adapted to be opened and closed and a drawstring for opening and closing the second end of the bag; and
moving the bag over the pet to clean or dry the pet.

18. The method of claim 17, further comprising directing the pet's head into the opening at the second end of the bag.

19. The method of claim 17, further comprising:
directing at least a portion of the pet's leg through the opening at the second end;
directing the pet's head toward a mesh opening in the bag; and
grooming the pet's nails of the leg inserted through the corner opening.
